(19) United States
(12) Patent Application Publication
(10) Pub. No.: US 2024/0181905 A1
(43) Pub. Date: Jun. 6, 2024

(54) APPARATUS AND SYSTEM FOR CONNECTING ELECTRIC VEHICLES TO AN ELECTRICAL NETWORK AND METHOD OF USE

(71) Applicant: TROJAN ENERGY LIMITED, Aberdeen (GB)

(72) Inventors: Ian MACKENZIE, Aberdeen (GB); Hugh MACKENZIE, Aberdeen (GB); Sandy THOM, Aberdeen (GB); Ashley THOMSON, Aberdeen (GB)

(21) Appl. No.: 18/284,942

(22) PCT Filed: Mar. 29, 2022
(86) PCT No.: PCT/GB2022/050778

§ 371 Date: Sep. 29, 2023

(30) Foreign Application Priority Data
Mar. 30, 2021 (GB) 2104493.8

(51) Int. Cl. B60L 53/16; B60L 53/62; B60L 53/63; B60L 53/66; B60L 53/67

(52) U.S. Cl. CPC B60L 53/16; B60L 53/62; B60L 53/63; B60L 53/665; B60L 53/67

(57) ABSTRACT

The invention provides an electric vehicle charging system, a property charge point unit for an electric vehicle charging system and a method of charging or discharging an electric vehicle. The system comprises a charge point connector configured to facilitate connection of an electric vehicle and a property charge point unit connected to a property electricity supply and configured to control transmission of energy between the property electricity supply and an electric vehicle connected to the charge point connector. The charge point connector of the system is located for connection to an electric vehicle parked in a publicly accessible area. The property charge point unit and the charge point connector are connected by at least one cable.

The present invention relates to a system for and method of connecting electric vehicles to an electrical network. In particular, the invention in one of its aspects relates to an electric vehicle charging system which provides electric vehicle users associated with a property with a privately controlled electric vehicle charging point. The invention in one of its aspects relates to apparatus, systems and methods for sharing a private electric vehicle charging point with third-party users.

### BACKGROUND TO THE INVENTION

The use of electric vehicles (EVs) in private and public transportation is increasing, leading to increasing demand for EV charging points. Many EV users or potential EV users do not have their own private driveway and they may have to park their EV on the street outside of their home. There is a need for on-street charging points and associated infrastructure, particularly in residential areas.

Whilst in some residential areas it is technically and economically viable for EV users and local authorities to work together to have public charge points installed on their residential street, for some users a privately controlled charge point is more desirable.

### SUMMARY OF THE INVENTION

It is amongst the aims and objects of the invention to provide a personal charge point for an EV which is appropriately located for on street charging.

In particular, one aim of an aspect of the invention is to provide a personal charge point for an EV which is appropriately located for on street charging which does not create any obstructions on the street or the pavement.

An additional aim of an aspect of the invention is to provide a personal charge point for an EV which is appropriately located for on street charging which facilitates a connection between an electric vehicle and a home electricity supply.

A further aim of an aspect of the invention is to provide a personal charge point for an EV which is appropriately located for on street charging which can be privately controlled and shared with other EV users to allow them to connect their EVs to the electrical network.

Other aims and objects of the invention will become apparent from the following description.

According to a first aspect of the invention there is provided an electric vehicle charging system comprising:
a charge point connector configured to facilitate connection of an electric vehicle to the charging system; and
a property charge point unit connected to a property electricity supply and configured to control transmission of energy between the property electricity supply and an electric vehicle connected to the charge point connector;
wherein the charge point connector is located for connection to an electric vehicle parked in a publicly accessible area; and
wherein the property charge point unit and the charge point connector are connected by at least one cable.

The electric vehicle charging system advantageously draws energy for charging an EV directly from the property electricity supply. The consumption of energy by EV users associated with the property—which, for example could be a home or a workplace—can be conveniently integrated into the electricity and/or utility bill for the property. The system also provides a convenient connection point for EV charging where the property does not have a private driveway or vehicle parking space.

The charge point connector may be available for private use only by EV users associated with the property.

Alternatively, the charge point connector may be publicly available for use (some or all of the time) by third-parties (i.e. users not associated with the property).

An owner and/or controller of the electric vehicle charging system associated with the property may be able to control the availability status of the charge point connector. In addition, the owner and/or controller of the electric vehicle charging system may be able to selectively control access of the charge point connector and limit access to specific third-parties.

Selective public availability of the charge point connector is advantageous because it allows public users to utilise the charge point connector when it is not in use by a user associated with the property or when an owner and/or controller of the system allows them to do so, therefore easing charge point demand. In addition, offering the charge point connector up for public use could allow a controller of the EV charging system to generate an income from their system (for example, where a third-party is charged a fee for the energy consumed to charge their EV and where a fee or a percentage of the charge is provided to the system owner and/or controller). The system owner/controller may receive payment and/or credit to an account for each third-party charging session.

The flexibility of being able to decide whether or not the charge point is available for public use is advantageous for the owner/controller of the system, because they can prioritise their own charging needs if and when they choose to do so.

The property charge point unit may be located proximate a property associated with the property electricity supply. Proximate a property shall be taken to mean on or in the property (externally or internally) or within the boundary of the property (for example, within a garden).

The charge point unit may be located wholly or partially underground.

Alternatively, the property charge point unit may be located remotely from the property.

The term publicly accessible area includes, but is not limited to: any type of street, road or highway which is near or beside where the property is located. This may also include a publicly accessible parking lot or a parking lot for restricted use (i.e. residents only), which is near or beside where the property is located. In most cases, this applies to a public street or road, where the property does not have a private driveway.

The at least one cable may be located fully or partially underground.

The charge point connector may be a low-profile charge point connector that may cause minimal obstruction to the publicly accessible area. For example, the charge point connector may be small in size.

The charge point connector may be located in the ground and may be substantially flush with an outer surface of the ground in which it is located, such that when it is not in use there is substantially no part of the charge point connector that protrudes from the ground. The ground includes, but is not limited to: a pavement, a walkway, a road, a street, a path, a kerb and/or a gutter. The charge point connector may be a female connector into which a male connector is operable to be inserted. The male connector may be a male connector associated with an EV.

The charge point connector and the male connector may be of similar design to the access connector and intermediate connector module described by the applicant's international patent application number PCT/GB2018/051809.

The system may comprise one or more additional charge point connectors connected to the property charge point unit. Where the system comprises more than one charge point connector, the system may facilitate load sharing between EVs connected to the charge point connectors. The energy distributed to some or all of the connectors (and therefore the connected EVs) may be adjusted (i.e. reduced or increased) depending on one or more of the following features: preferences of the system owner and/or controller, a selection of the system owner and/or controller, preferences of any third-parties connected to the system, selection of any third-parties connected to the system, energy demand (of the property electricity supply and/or of a wider electricity network), and/or peak consumption periods (of the property electricity supply and/or of a wider electricity network).

An owner/controller and/or authorised user of the EV charging system may communicate with one or more data processing means, which may be done using a device associated with the owner/controller and/or the user and/or the property charge point unit. Such a device may be a user interface (UI) device such as a smart phone, a tablet or a computer.

The one or more data processing means may be alerted when the status of the charge point connector (or multiple charge point connectors where provided) is set to publicly available (i.e. available for public use by third-parties).

The owner/controller of the system may be able to selectively permit access to only some, authorised third-parties.

Alternatively, or in addition, a third-party may communicate with the one or more data processing means.

The third-party may communicate with the owner/controller of the system via the one or more data processing means and/or one or more devices to request use of the system.

The third-party (or a device associated with the third-party) may alert the system and/or the one or more data processing means when an EV associated with the third-party is connected to the system.

The one or more data processing means may receive metering data from the system relating to the consumption of the third-party, and appropriately facilitate billing of the third-party for the consumption. The one or more data processing means may facilitate payment to the owner/controller of the system for the consumption of the third-party. The payment may be in the form of a cash payment and/or credit to an account associated with the owner/controller of the system.

The property charge point unit may be connected to an existing meter in the property for the property electricity supply.

The existing meter may combine metering of the property electricity supply usage with energy consumption of the electric vehicle charging system.

The property charge point unit may be connected to an existing consumer unit in the property for the property electricity supply.

The property charge point unit may be located between the existing meter in the property and/or the existing consumer unit in the property and the charge point connector (or connectors).

The property charge point unit may comprise a controls channel and a power channel. The power channel may comprise a residual current device (RCD), a Protective Earth Monitor and/or a contactor. When an EV is connected to the charge point connector of the system, the Protective Earth Monitor is used to assure that there is a good, safe connection between the EV and the system. The transfer of energy may not take place without this assurance.

The power channel may comprise a dedicated EV charging system meter. The dedicated meter may independently meter energy consumption of the electric vehicle charging system separately from other usage of the property electricity supply.

The property charge point unit and/or the dedicated meter may communicate with a central communications system or network (for example, a system which is known in the United Kingdom as The Data Communications Company or The DCC) which may transfer data between energy suppliers and/or other meters within a wider network of energy users, to regulate energy consumption across the wider network. This may be done using cloud communication and/or any other applicable communications protocol. The electric vehicle charging system may adjust the energy distributed to one or more of the connectors (and therefore the connected EVs) based on data, instructions and/or requests provided by or via the central communications system or network.

Alternatively, or in addition, the property charge point unit may be connected to a smart meter. The smart meter may be an existing smart meter of the property. Alternatively, the smart meter may be a dedicated smart meter for the system, which may be located inside the property charge point unit or which may be connected to the property charge point unit. The smart meter may communicate with a central communications system or network (such as The DCC) which may transfer data between energy suppliers and/or other meters within a wider network of energy users, to regulate energy consumption across the wider network. The electric vehicle charging system may adjust the energy distributed to some or all of the connectors (and therefore the connected EVs) based on data, instructions and/or requests provided by or via the central communications system or network.

According to a second aspect of the invention there is provided a property charge point unit comprising:
a first connection point configured to be connected to a property electricity supply; and
a second connection point configured to be connected to at least one charge point connector for facilitating connection of an electric vehicle to the charging system;
wherein the property charge point unit is configured to be located between an existing consumer unit and/or meter in the property for the property electricity supply and the charge point connector; and
wherein the property charge point unit is configured to control transmission of energy between the property electricity supply and an electric vehicle connected to the charge point connector.

The property charge point unit may comprise a controls channel and a power channel.

The power channel may comprise a residual current device (RCD), a Protective Earth Monitor and/or a contactor.

The charge point unit may be operable to communicate with a central communications system (for example, a system which is known in the United Kingdom as The Data Communications Company or the DCC) which may transfer data between energy suppliers and/or other meters within a wider network of energy users, to regulate energy consumption across the wider network. This may be done using cloud communication and/or any other applicable communications protocol. The charge point unit may be configured to adjust the energy distributed to the at least one charge point connector (and therefore a connected EV) based on data, instructions and/or requests provided by or via the central communications system or network.

The power channel may further comprise a dedicated EV charging system meter.

The EV charging system meter may be configured to independently meter energy consumption drawn from the at least one charge point connector separately from the existing meter in the property for the property electricity supply.

The EV charging system meter may be a standard meter. The EV charging system meter may be a smart meter.

The EV charging system meter may be operable to communicate with a central communications system (for example, a system which is known in the United Kingdom as The Data Communications Company or the DCC) which may transfer data between energy suppliers and/or other meters within a wider network of energy users, to regulate energy consumption across the wider network. This may be done using cloud communication and/or any other applicable communications protocol. The charge point unit may be configured to adjust the energy distributed to the at least one charge point connector (and therefore a connected EV) based on data, instructions and/or requests provided by or via the central communications system or network.

The first connection point may be configured to be connected to a property electricity supply via a smart meter. The smart meter may be the existing meter in the property for the property electricity supply or it may be an additional dedicated smart meter for the property charge point unit.

The smart meter may be operable to communicate with a central communications system (for example, a system which is known in the United Kingdom as The Data Communications Company or the DCC) which may transfer data between energy suppliers and/or other meters within a wider network of energy users, to regulate energy consumption across the wider network. This may be done using cloud communication and/or any other applicable communications protocol. The charge point unit may be configured to adjust the energy distributed to the at least one charge point connector (and therefore a connected EV) based on data, instructions and/or requests provided by or via the central communications system or network.

The property charge point unit may be operable to communicate with one or more data processing means and/or one or more devices associated with an owner/controller of an EV charging system. The owner/controller of the EV charging point may transmit data and/or instructions to the property charge point unit via the one or more data processing means and/or the one or more devices. For example, the owner/controller may inform the property charge point unit that the at least one charge point connector should be made available for public use, for select use (i.e. for use by select third-parties) or for private use.

The property charge point unit may be operable to send instructions to the charge point connector to actuate it to lock and/or unlock.

Embodiments of the second aspect of the invention may include one or more features of the first aspect of the invention, or vice versa.

According to a third aspect of the invention there is provided a method of charging an electric vehicle, the method comprising:
connecting an electric vehicle to a charge point connector of the electric vehicle charging system according to the first aspect of the invention; and
transmitting energy between the property electricity supply and the electric vehicle;
wherein the property charge point unit is configured to control the transmission of energy between the property electricity supply and the electric vehicle.

Where the electric vehicle charging system comprises more than one charge point connector, the method may comprise connecting an electric vehicle to one of the charge point connectors. Where EVs are connected to multiple charge point connectors, the method may comprise controlling the distribution of energy between the charge point connectors.

The property charge point unit may be operable to communicate with one or more data processing means and/or one or more devices associated with an owner/controller of an EV charging system.

The owner/controller of the EV charging system may transmit data and/or instructions to the property charge point unit and/or the charge point, which may be via the one or more data processing means and/or the one or more devices.

For example, the owner/controller may inform the property charge point unit that the at least one charge point connector should be made available for public use, for select public use (i.e. for use by select third-parties) or for private use.

The method may comprise alerting third-party EV users that a charge point connector of the electric vehicle charging system is available for public use. The alert may be transmitted using the internet. The EV user may be alerted via e-mail and/or via a notification of an application on their tablet, computer or mobile phone.

The method may comprise authorising a third-party EV user to use the system.

The method may comprise identifying a third-party EV user who wishes to use the system and verifying that the EV user is an authorised user.

The method may comprise unlocking a charge point connector of the electric vehicle charging system for public use.

The method may comprise unlocking a charge point connector of the electric vehicle charging system for use by an authorised user.

The method may comprise identifying a third-party and unlocking a charge point connector following identification of the third-party.

The charge point connector may be operable to identify a device of the third-party (for example, a third-party connector device for connection with the charge point connector).

Alternatively, or in addition, the third-party and/or the system controller/owner may send an instruction to the system, to instruct the charge point connector to open.

The method may comprise billing the third-party for the energy consumed during charging. An owner/controller of the EV charging system may receive some or all of the third-parties payment.

Embodiments of the third aspect of the invention may include one or more features of the first or second aspects of the invention, or their embodiments, or vice versa.

According to a fourth aspect of the invention there is provided a method of discharging an electric vehicle, the method comprising:
connecting an electric vehicle to a charge point connector of the electric vehicle charging system according to the first aspect of the invention; and
transmitting energy between the electric vehicle and the property electricity supply;
wherein the property charge point unit is configured to control the transmission of energy between the electric vehicle and the property electricity supply.

Embodiments of the fourth aspect of the invention may include one or more features of the first to third aspects of the invention, or their embodiments, or vice versa.

### Brief Description of Drawings

There will now be described, by way of example only, an embodiment of the invention with reference to the following drawings, of which:

FIG. 1 is a perspective view of an EV charging system according to an embodiment of the invention;

FIG. 2 is a schematic physical representation of an EV charging system according to an embodiment of the invention;

FIG. 3 is a schematic representation of the functional elements of a household charge point unit according to an embodiment of the invention; and

FIG. 4 is a schematic representation of the functional elements of a household charge point unit according to an embodiment of the invention.

### DETAILED DESCRIPTION

Throughout this specification, the term “electric vehicle” or “EV” (used interchangeably) shall be taken to have its conventional meaning. This term shall also be taken to include any kind of battery electric vehicle, plug-in hybrid vehicles, motorcycles and power-assist bicycles.

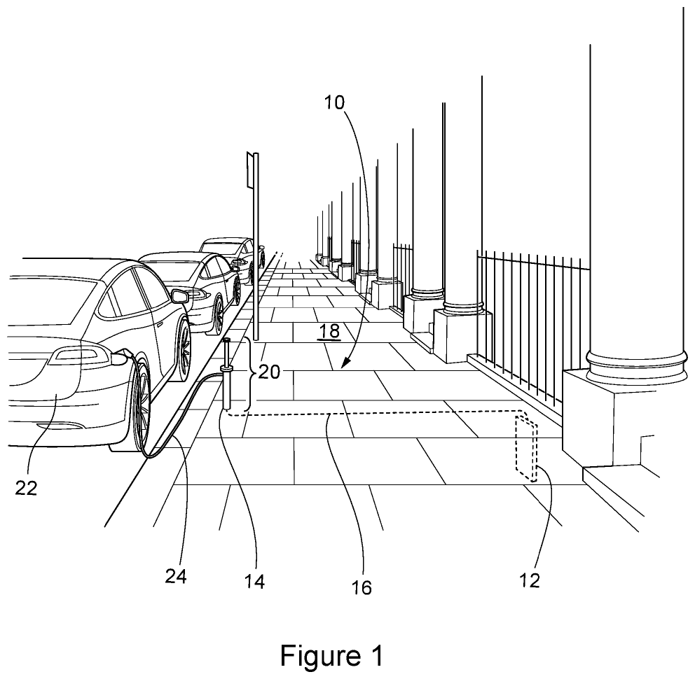

Referring firstly to FIG. 1 there is shown, generally at 10, an EV charging system according to an embodiment of the present invention. The charging system 10 is installed on a residential street, to provide the resident (or residents) of a home on the street with their own, personal charging point for an EV, which is ideally located for connection to an EV which is parked on the street. The system 10 is beneficial because it provides the residents of the home with a dedicated EV charging point, despite this typically being reserved for residents of a home having a private driveway (i.e. off-street parking).

The system 10 comprises a household charge point unit 12 connected to a charge point connector 14 by a sub-terranean cable 16 which runs underneath the pavement 18.

Although not shown, the household charge point unit 12 is connected to the electricity supply of the home which it is adjacent to.

The power and control components that would usually be found in a typical EV charging station are instead provided in the household charge point unit 212. In this way, the charge point connector 14 serves as a simple electrical connection point for an EV to the charging system 10 and can therefore be compact in size and able to be installed in/under the pavement 18. There is no need to also install the other components usually associated with an EV charging station underground, thus requiring extensive excavation, or alternatively to provide these in the form of a traditional charging station unit, which is upstanding from the ground and which causes an obstruction to the pavement or roadway on which it is installed.

The charge point connector 14 is substantially flush with an outer surface of the pavement and provides an access point for an EV to connect to the home electricity supply for charging. The charge point connector 14 is a socket-type female connector into which a male connector 20 can be inserted. The male connector 20 is a portable unit in the form of a rod (otherwise referred to as a lance) which, when not in use, may be carried in an EV.

In use, as shown in FIG. 1, a first end of the male connector 20 is inserted into the charge point connector 14 and a second end of the male connector 20 is connected to an EV 22 by a cable 24. The first end of the connector 20 is designed to securely, easily, and reliably connect to the charge point connector 14. An end of the cable 24 may be detachable from the second end of the male connector 20 by an appropriate connection means. At its other end, the cable 24 is connected to the EV 22 by a standard EV connector (for example, an industry standard “type 2” connector). When inserted, an electrical connection is formed between the male connector 20 and the charge point connector 14, to connect the EV 22 to the home electricity supply. The charge point connector 14 can be operatively locked an unlocked to permit insertion of the male connector 20.

The household charge point unit 12 is shown in FIG. 1 as being located on a wall of the home, but it could equally be located in a garden or in any other convenient location for the home. As the household charge point unit 12 is installed on private property, it does not create an obstruction to other residents on the street or to other people using or walking on the street or the pavement.

Similarly, the position of the cable 16 beneath the pavement means that it does not create a dangerous tripping hazard for people walking on or using the street. It is additionally protected from adverse weather and likewise from theft or tampering. It will be appreciated that the system can also be installed in streets which are arranged differently to that which is shown in FIG. 1 (for example, where there is no pavement or walkway) and the cable 16 will be located appropriately. In embodiments of the invention, the cable may also be installed above ground.

Moreover, the nature of the charge point connector 14—being a socket-type female connector which is substantially flush with an outer surface of the pavement 18—is similarly advantageous in that, when it is not in use, the charge point connector 14 does not create an obstruction on the street. It will be appreciated that the connector 14 can be installed in other locations, in particular, other locations in which it is substantially flush with a surface of the ground (for example, in a roadway or a kerbstone).

Although the charging system is described as being connected to a home for use by residents, it can also be used by anyone with appropriate permissions to do so. For example, a visitor or a guest to the home. In an embodiment of the invention described in more detail below, the owner and/or controller of a charging system according to the invention may permit third-party users to access a charge point connector of the system. In such cases, the system owner/controller may receive a fee from the third-party users in exchange for the energy provided to their EV during charging (for example, a mark-up on the unit price of the energy sold). In this way, the owner/controller of the system can choose how they would like the system to be utilised and change the status of the system as and when this is convenient for them. If they know that they do not need to use the charging point on a certain day then they can generate revenue from the system by opening it up for public use. In addition if, for example, the owner/control prefers to charge their EV during the night (to take advantage of cheaper rates), they can set the system up for private use only during these times.

It will be appreciated that although the charging system is described with reference to a residential home and home residents, a similar charging system could be connected to different types of buildings for different categories of users. For example, a charging system like that described above could be connected to a workplace, owned and/or controlled by an employer and be made available for use by employees.

It will be appreciated that, whilst only a single sub-terranean cable 16 is mentioned, multiple cables can be provided between the charge point unit and the charge point connector. In addition, multiple charge point connectors may be connected to a single charge point unit.

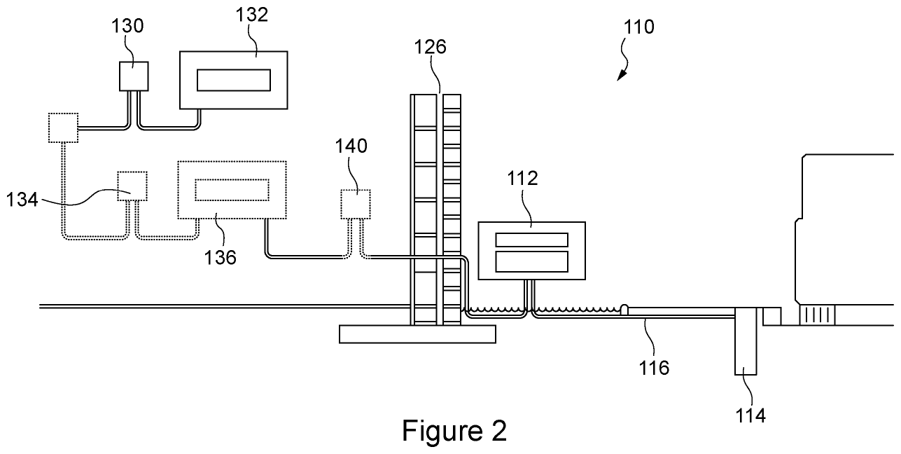

FIG. 2 shows, schematically, an EV charging system 110 similar to that of FIG. 1 in more detail. Like features are given like reference numerals, incremented by 100. More specifically, FIG. 2 shows how the household charge point unit 112 is connected to the home electricity supply, which is located on the internal side of a home wall 126. The household charge point unit 112 is located externally to the home wall 126 in a garden of the home and connected to the charge point connector 114 by a sub-terranean cable 116, which runs under the garden and a pavement 118. The components located within the home which are shown in dashed lines are optional for some embodiments of the invention, and their functions will become apparent throughout the following description.

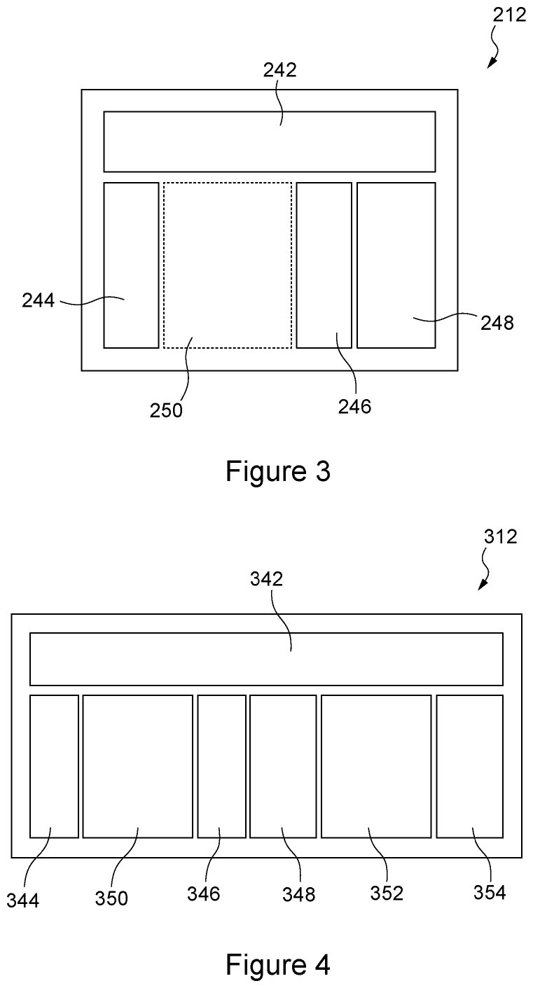

In the simplest form of the EV charging system 110, the household charge point unit 112 is connected to the existing meter 130 and consumer unit 132 for the household. FIG. 3 shows a household charge point unit 212 which is suitable for use in this configuration of the EV charging system 110.

The power and control components that would usually be found in a typical EV charging station are instead provided in the household charge point unit 212. The household charge point unit 212 comprises a controls channel 242 and a power channel comprising a residual current device (RCD) 244, a Protective Earth Monitor 246 and a contactor 248.

In this arrangement, the electricity which is drawn from an EV connected to the charge point connector 114 during charging is metered by the existing home meter 130 and the cost for charging is amalgamated into the utility bill for the household. This is useful for residents of the home, because it streamlines and simplifies their household utility billing, by incorporating EV charging costs into household usage costs.

Optionally, the household charge point unit 212 can comprise its own meter 250. This enables the electricity drawn from an EV connected to the charge point connector 114 to be metered separately from the household's energy consumption, therefore generating metering data specifically relating to EV charging (i.e. the amount of energy provided to a connected EV and the associated time of supply). This can be useful if the owner/controller of the EV charging system decides to implement sharing of the connector 114, by making the charge point connector 114 available for public use by third-parties. The charge point connector could be advertised, for example, using a web-based service and/or a mobile application as being available for use for other EV users.

Data from the meter 250, along with the public availability status of the EV charge point connector, can be used to make a determination as to whether a third-party has used or is using the system 110 to charge their EV. Additionally, the time of use and the energy consumed during the charging session can be determined from the meter 250.

For example, where the meter records consumption during a time in which the charge point connector is known to be available for public use, it can be determined that the EV of a third-party is connected to the charge point connector and is charging via the EV charging system. A cost can be allocated to the charging session depending on and/or proportionate to the energy consumption. The cost can be charged to the third-party. The owner/controller of the EV charging system will receive some or all of this charge. A proportion of the charge may also be paid to an external entity (for example, this could be a company which facilitates the public sharing service by identifying the occurrence of a third-party charging session using the relevant data which is communicated to it and calculating the associated cost).

The charge point unit 212 meter 250 can be controlled by a different entity than the meter located in the home (i.e. by an entity other than the home utility provider). It can also communicate with a data processing means (which may, for example, be a cloud-based data processing means) to transmit the metering data (including usage information) to the data processing means. The owner/controller of the system may additionally communicate with the same data processing means (or another data processing means operable to communicate with the aforementioned data processing means) to inform it that the charge point connector is currently available for public use. Alternatively, or in addition, the third-party (or a device associated with the third-party) can communicate with the same data processing means (or a further data processing means operable to communicate with the aforementioned data processing means) to inform it that it is using the EV charging system. This could be particularly useful where the owner/controller of the EV charging system has made the decision that it will generally always be available for public connection (when not in use by a resident of the home associated with the system).

The following information could be used to determine whether a public, third-party
charging session is or has taken place:
data from the meter 250 relating to consumption;
and
data indicating that the EV charge point connector is available for public use; and/or
data indicating that the EV charge point connector is being used/has been used by a third-party; and/or
data indicating that the EV charge point connector is not being used by the owner/controller or another private user associated with the system.

In one example, a communication signal could be generated when a male connector of a third-party user is connected to a charge point connector of the charging system, indicating that the charge point connector is being used by the third-party. The consumption which is metered throughout the duration of this connection can be appropriately billed to the third-party in favour of the system owner/controller.

Before connection to an EV is made, the charge point connector can be adapted to detect a male connector in its proximity and identify whether the connector belongs to the system owner/controller or a third-party, and additionally whether the third-party is a third-party who is authorised to use the system for charging (for example, using RFID technology). If the charge point connector senses that the male connector of an authorised user is near, it may automatically unlock. The identification can also be used to determine that a third-party charging session is occurring, and to whom billing should be directed. Other methods of unlocking a charge point connector to permit the insertion of a male connector of authorised users only could also be employed. For example, a key-pad could be provided for the authorised user to key in an authorisation code, which could be communicated to him or her via an email or app notification. Alternatively, an authorised user or the system owner/controller could send a signal, using a device associated with them, to the charge point connector, the household charge point unit and/or a remote data processing means in communication with either component to instruct the charge point connector to open. Again, this identification could be used to identify and appropriately bill the charging session.

Although there is only one charge point connector shown as being connected to the household charge point unit 212, it will be appreciated that multiple charge point connectors can be connected to the unit in the same manner. In such an arrangement, the unit 212, or one or more data processing means (not shown) connected to the unit 121, can facilitate energy sharing between the multiple charge point connectors which are in use, which can depend on the demand on the system. For example, during high demand or peak periods, the energy supplied to one or more EVs connected to the system may be reduced. The system could be instructed to prioritise the owner/controller of the EV system, so that their supply is not interrupted, whilst any third-parties connected to other connectors of the system are provided with a reduced supply.

The household charge point unit 212 may be capable of communicating with a central communications system (for example, a system which is known in the United Kingdom as The Data Communications Company or the DCC) to be provided with demand information relating to a wider network (for example, a wider electrical network or specifically a wider network of EV charging points and systems), and vary supply to EVs connected to the system 110 accordingly, based on the wider demand. This may be a result of an instruction or request provided by the central communication system or by an independent determination made by the EV charging system 110. The household charge point unit 212 and/or meter 250 may communicate with the central communications system using cloud communications.

Alternatively, where the existing meter 130 inside the home is a smart meter which is capable of communicating with a central communications system, the household charge point unit 212 and/or meter 250 may communicate with the central communications system via the existing home meter 130.

Referring back to FIG. 2, in an alternative configuration the EV charging system comprises an additional meter 134 and consumer unit 136 which are installed inside the home, and connected to the existing meter 130 and consumer unit 132 of the home. The meter 134 and consumer unit 136 are located inside the home to share the home circuit breaker (not shown); however, it will be appreciated that in alternative embodiments of the invention these components may be relocated (for example, to locations outside of the home, such as in the household charge point unit). The dedicated meter 134 is a smart meter. The FIG. 3 household charge point unit 212 (without the optional feature of the meter 250) is suitable for use in this configuration of the EV charging system 110.

This system configuration similarly enables the electricity drawn from an EV connected to the charge point connector 114 (or to one of the charge point connectors where there are multiple connectors in the system) to be metered separately from the household's energy consumption by the smart meter 134, therefore generating metering data relating to the amount of energy provided to a connected EV and the associated time of supply. Again, this can be useful if the owner/controller of the EV charging system decides to share the charge point connector 114 (or connectors) with third-parties, for public use, and can operate in substantially the same manner as described above.

In this configuration, the smart meter 134 itself is capable of communicating with a central communications system (for example, a system which is known in the United Kingdom as The Data Communications Company or the DCC) to be provided with demand information relating to a wider, and vary supply to EVs connected to the system 110 accordingly based on the wider demand, whether this is the result of an instruction or request provided by the central communication system or an independent determination made by the EV charging system 110 based on information provided to it.

Referring again back to FIG. 2, in an alternative configuration of the system 110 an isolator 140 is provided inside the home. This configuration facilitates discharge of energy stored in the battery of an EV connected to the system 110 via the charge point connector 114 back to the electricity network—commonly known as Vehicle-to-Grid or V2G—by enabling the household to be safely isolated from the EV supply. This can be done in combination with any of the arrangements and principles described above. Instead of discharging and selling energy back to the electricity network (such as the national grid), the system could similarly be used to transfer energy back to the home (or property). This could be done, for example, during peak times, to ease demand.

The household charge point unit of FIG. 3 is suitable for use in this configuration, where the EV discharge output is in AC. Alternatively, the household charge point unit 312 of FIG. 4, which additionally includes an inverter 352 and an isolator 354, can be used where the EV discharge output is in AC or DC. The inverter 352 operates when the EV discharge output is in DC to convert it to AC.

The owner and/or controller of the system can receive payment or credit to an account (such as his or her home utility account) as a result of discharging energy from their EV using the system.

The system 110 could be similarly made available for third-party use, as described above, for V2G implementations (and similar implementations for transferring energy back to the home or property) to enable third-parties (i.e. members of the public) to connect to the system 110 and sell energy from their EV to the electrical network using the system 110. Billing implementations could allow for the third-party to receive payment for the energy that they have sold, whilst also paying a fee to the EV system owner/controller (for example, a percentage of the payment received for the sold energy) for use of the system.

In the embodiments of the invention described above, the power supply which is provided to an EV connected to the system originates from the household supply. Ordinarily, household supply is single-phase electric power; however, where a household has upgraded to three-phase electric power, this can be provided to the charging system. Where the system comprises more than one connector, each connector can interchangeably be supplied with different phases of electric power (for example to implement energy sharing and/or to pay less for the energy consumed). Where there is a single connector, it may be provided with single-phase or three-phase electric power.

Throughout this specification, references which are made to communication and data transfer and the like may refer to communication made using wired communication methods or wireless communication protocols, including but not limited to, LoRaWAN, Wi-Fi, cellular (for example, 4G or 5G), Zigbee and/or Bluetooth.

The invention provides an electric vehicle charging system, apparatus for use in an electric vehicle charging system and methods of using an electric vehicle charging system. The system comprises a charge point connector configured to facilitate connection of an electric vehicle to the charging system and a property charge point unit connected to a property electricity supply and configured to control transmission of energy between the property electricity supply and an electric vehicle connected to the charge point connector. The charge point connector is located for connection to an electric vehicle parked in a publicly accessible area and the property charge point unit and the charge point connector are connected by at least one cable.

Various modifications to the above-described embodiment may be made within the scope of the invention, and the invention extends to combinations of features other than those expressly claimed therein.

1. An electric vehicle charging system comprising:
a charge point connector configured to facilitate connection to an electric vehicle; and
a property charge point unit connected to a property electricity supply and configured to control transmission of energy between the property electricity supply and an electric vehicle connected to the charge point connector;
wherein the charge point connector is located for connection to an electric vehicle parked in a publicly accessible area; and
wherein the property charge point unit and the charge point connector are connected by at least one cable.

2. The electric vehicle charging system according to claim 1, wherein the charge point connector is located in the ground and is substantially flush with an outer surface of the ground.

3. The electric vehicle charging system according to claim 1, wherein the system comprises one or more additional charge point connectors connected to the property charge point unit.

4. The electric vehicle charging system according to claim 3, wherein the system facilitates load sharing between electric vehicles connected to the charge point connector and the one or more additional charge point connectors and wherein the energy distributed to some or all of the charge point connector and the one or more additional charge point connectors is adjusted depending on one or more of the following features: preferences of a system owner and/or controller, a selection of the system owner and/or controller, preferences of any third-parties connected to the system, selection of any third-parties connected to the system, energy demand of the property electricity supply and/or of a wider electricity network, and/or peak consumption periods of the property electricity supply and/or of a wider electricity network.

5. The electric vehicle charging system according to claim 1, further comprising a data processing means.

6. The electric vehicle charging system according to claim 5, wherein a system owner and/or controller and/or an authorised user of the electric vehicle charging system can communicate with the data processing means using a device associated with them, the charge point connector and/or the property charge point unit.

7. The electric vehicle charging system according to claim 6, wherein the charge point connector is configured to be selectively available for public use by third-parties not associated with the property or the electric vehicle charging system of the property.

8. The electric vehicle charging system according to claim 7, wherein the data processing means is configured to receive information relating to the availability status of the charge point connector, the availability status being selected from one or more of the following: available for private use only by a system owner, system controller and/or users associated with the property; available for public use by third-parties not associated with the property or the electric vehicle charging system of the property; and available for selective public use by authorised third-parties not associated with the property or the electric vehicle charging system of the property.

9. The electric vehicle charging system according to claim 7, wherein the data processing means is configured to receive metering data from the electric vehicle charging system relating to the energy consumption of a third-party who is using or has used the system to facilitate billing of the third-party for the energy consumption.

10. The electric vehicle charging system according to claim 1, wherein the property charge point unit is connected to an existing consumer unit in the property for the property electricity supply.

11. The electric vehicle charging system according to claim 10, wherein the property charge point unit is located between an existing consumer unit in the property and the charge point connector.

12. A property charge point unit for controlling transmission of energy between a property electricity supply and an electric vehicle comprising:
a first connection point configured to be connected to a property electricity supply; and
a second connection point configured to be connected to at least one charge point connector for facilitating connection of an electric vehicle to the charging system;
wherein the property charge point unit is configured to be located between an existing consumer unit and/or meter in the property for the property electricity supply and the charge point connector; and
wherein the property charge point unit is configured to control transmission of energy between the property electricity supply and an electric vehicle connected to the charge point connector.

13. The property charge point unit according to claim 12, further comprising a controls channel and a power channel, wherein the power channel comprises a residual current device (RCD), a Protective Earth Monitor and/or a contactor.

14. The property charge point unit according to claim 12, wherein the power channel of the property charge point unit comprises a dedicated electric vehicle charging system smart meter configured independently meter energy consumption of the electric vehicle charging system separately from energy consumption of the property electricity supply.

15. The property charge point unit according to claim 12, wherein the first connection point is configured to be connected to the property electricity supply via a smart meter.

16. The property charge point unit according to claim 14, wherein the smart meter is operable to communicate with a central communications system which is configured to transfer data between energy suppliers and/or other meters within a wider network of energy users to regulate energy consumption across the wider network.

17. A method of charging or discharging an electric vehicle, the method comprising:
connecting an electric vehicle to a charge point connector of the electric vehicle charging system according to any of claims 1 to 11; and
transmitting energy between the property electricity supply and the electric vehicle; wherein the property charge point unit is configured to control the transmission of energy between the property electricity supply and the electric vehicle.

18. The method according to claim 17, wherein the electric vehicle charging system comprises more than one charge point connector and wherein the method comprises controlling the distribution of energy between multiple charge point connectors of the more than one charge point connector.

19. The method according to claim 17, wherein the property charge point unit is operable to communicate with a data processing means and wherein the method comprises transmitting data and/or instructions from a system owner, a system controller, or an authorised user to the property charge point unit and/or the charge point via the data processing means.

20. The method according to claim 17, comprising alerting third-party electric vehicle users that the charge point connector is available for public use.

21. The method according to claim 17, comprising unlocking the charge point connector for public use.

22. The method according to claim 21, comprising unlocking the charge point connector following identification of third-party electric vehicle users.

23. The method according to claim 21, comprising unlocking the charge point connector in response to an instruction received from a system owner, a system controller, an authorised user and/or a third-party electric vehicle user.

24. The method according to claim 17, comprising allocating a charging session cost to a third-party charging session depending on the energy consumed and requesting payment from the third-party.

25. The method according to claim 24, wherein a system owner receives payment from the third-party for the charging session, and the method comprises using the data processing means to facilitate the transfer of some or all of the payment from the third-party to the system owner.
